(19) United States
(12) Patent Application Publication
(10) Pub. No.: US 2021/0334653 A1
(43) Pub. Date: Oct. 28, 2021

(54) HYBRID DEEP LEARNING SCHEDULING METHOD FOR ACCELERATED PROCESSING OF MULTI-AMI DATA STREAM IN EDGE COMPUTING

(71) Applicant: Korea Advanced Institute of Science and Technology, Daejeon (KR)

(72) Inventors: Chan Hyun Youn, Daejeon (KR); Chang Ha Lee, Daejeon (KR); Seong Hwan Kim, Daejeon (KR)

(21) Appl. No.: 17/231,738

(22) Filed: Apr. 15, 2021

(30) Foreign Application Priority Data
Apr. 22, 2020 (KR) 10-2020-0048531

(51) Int. Cl. G06N 3/08; G06N 3/04

(52) U.S. Cl. CPC G06N 3/08; G06N 3/04

(57) ABSTRACT

Disclosed is a hybrid deep learning scheduling method for accelerated processing of a multi-advanced metering infrastructure (AMI) data stream in edge computing, wherein a skewed data distribution change, which occurs in AMI data, is detected, an edge server computes an online gradient, which is comparatively quickly computed, on the basis of the detected change, a cloud server computes a normalized gradient, which requires a large amount of computation, according to selection by a hybrid scheduler, and the hybrid scheduler performs a total of three operations: (1) a data stream distribution profiling operation, (2) a memory buffer update operation, and (3) a hybrid scheduling operation.

### CROSS-REFERENCE TO RELATED APPLICATION

This application claims priority to and the benefit of Korean Patent Application No. 10-2020-0048531, filed on Apr. 22, 2020, the disclosure of which is incorporated herein by reference in its entirety.

### BACKGROUND

### 1. Field

The present invention relates to a hybrid deep learning scheduling method for accelerated processing of multi-advanced metering infrastructure (AMI) data streams in edge computing and, more particularly, to a hybrid deep learning scheduling method for accelerated processing of multi-AMI data stream in edge computing, the hybrid deep learning scheduling method being capable of reducing the overall system load by performing gradient scheduling in an edge-cloud environment.

### 2. Discussion of Related Art

In general, in an advance metering infrastructure (AMI), which specifies the amounts of power consumption of individual households and transmits them as data, a statistical technique or a machine learning technique is used to perform data analysis in order to perform power consumption pattern-based prediction or interpolate missing data due to transmission errors or system failures.

However, recently, research results showing that conventional statistical techniques or machine learning techniques have lower analysis accuracy than deep learning techniques have been published. In particular, in order to process an AMI data stream with statistical characteristics changing over time, it is necessary to continuously train a deep learning model for analyzing time-series data with the statistical characteristics with time.

When multi-AMI data is continuously learned over time, conventional machine learning techniques including a k-nearest neighbor (k-NN) algorithm and a k-means algorithm have to be able to cope with data characteristics that change over time.

According to the previously published technology, the k-nearest neighbor (k-NN) algorithm is used to interpolate unexpectedly missing data occurring over time. In this case, unexpected data that deviates from the existing data distribution is interpolated by referring to similar past tastes. However, according to the previously published experimental results, the interpolation accuracy of missing data for low-voltage power, which has a larger data characteristic change than high-voltage power, is low. Also, since the conventional techniques do not consider a multi-AMI data stream situation, it is difficult to apply the techniques to an actual AMI data management and analysis system.

According to a paper recently published in the field of missing data interpolation, a deep learning-based autoencoder technique that has higher interpolation accuracy than the k-nearest neighbor (k-NN) algorithm method and that is effective for a wider range of missing data has been proposed.

Therefore, it is necessary to apply deep learning techniques, which are more effective than machine learning techniques, in interpreting AMI data, but deep learning, like machine learning, needs a technique that reflects data characteristics that change over time.

Accordingly, recently, an online training method that enables a model to incrementally learn input stream data with new data characteristics, rather than to learn all data sets once, through incremental learning has been proposed.

However, when the deep learning technique using the incremental learning is actually applied to an AMI management and analysis platform (MDMS), the following problems arise.

Basically, the increase in processing time due to numerous model parameters and complex computation process in the deep learning model causes large system load. Therefore, using a deep learning model that has trained data on multiple users, rather than training individual deep learning models, is effective in reducing system load.

However, the incremental learning is effective only in a situation where a data distribution does not change significantly and does not show good learning performance in a situation where a data distribution changes significantly. When the power pattern of multiple users shown previously is learned, a change in the data distribution that occurs when the amounts of power consumption of completely different users are learned is greater than a change in the data distribution of the same user with time.

This is a problem that may arise due to changes in user-specific skewed data distributions when the change in the data distribution of the multi-AMI stream data is actually checked based on the cosine similarity frequency distribution. In addition, this is also a problem that may occur when the incremental learning is actually applied to a big-data processing system.

Meanwhile, a continuous learning technique uses a memory buffer Mₜ with limited capacity to store a small amount of already learned data and stores data examples. A gradient gₖ (1≤k≤t) to be used in a deep learning model optimization process is computed by using a memory buffer with prestored image classes when a new image class is learned, and a gradient g to also be used in the deep learning model optimization process is computed by passing image class data currently being learned through the deep learning model.

In order to compute a normalized gradient \tilde{g} or a gradient reflecting previous information, which allows an inner product between the previous gradient and the current gradient to always become a positive real number, the following optimization problem is solved. When model parameters are updated with a computed projection gradient \tilde{g}, the model may perform learning without forgetting information learned with the previous image class in a situation where the classes gradually increase.

However, the above method requires a great deal of additional computation time because a quadratic program should be solved to find \tilde{g}. Using this method for online learning is not easy due to the additional computation time as well as the long training time required by the complex computation process of the deep learning model itself.

The background of the present invention is disclosed in Korean Patent Application Publication No. 10-2018-0082606 (published on Jul. 18, 2018 and entitled “Computer architecture and method for modifying data intake parameters based on a predictive model”).

### SUMMARY

According to an aspect of the present invention, the present invention was created to solve the above problems and is directed to providing a hybrid deep learning scheduling method for accelerated processing of multi-AMI data stream in edge computing, the hybrid deep learning scheduling method being capable of reducing the overall system load by performing gradient scheduling in an edge-cloud environment.

According to an aspect of the present invention, there is provided a hybrid deep learning scheduling method for accelerated processing of a multi-advanced metering infrastructure (AMI) data stream in edge computing, wherein a skewed data distribution change, which occurs in AMI data, is detected, an edge server computes an online gradient, which is comparatively quickly computed, on the basis of the detected change, a cloud server computes a normalized gradient, which requires a large amount of computation, according to selection by a hybrid scheduler, and the hybrid scheduler performs a total of three operations: (1) a data stream distribution profiling operation, (2) a memory buffer update operation, and (3) a hybrid scheduling operation.

In (1) the data stream distribution profiling operation, the hybrid scheduler may determine whether a change in the distribution occurs by recognizing a frequency distribution on the basis of cosine similarity in a stream set Sᵢ={x_{i,1}^{p}, x_{i,2}^{p}, . . . , x_{i,k}^{p}} in which p-dimensional power consumption AMI data xᵢ^{p} is collected for each stream arrangement i.

In (2) the memory buffer update operation, the hybrid scheduler may store a new data distribution in a memory buffer when it is determined that a distribution change has occurred.

In (3) the hybrid scheduling operation, the hybrid scheduler may perform a scheduling technique to solve a problem related to the skewed data distribution change according to a new data distribution.

The hybrid scheduler may instruct the edge server to compute an online gradient when a new data stream is input, and in (1) the data stream distribution profiling operation, the hybrid scheduler may compute a cosine similarity index from a data stream with respect to a vector \vec{1} that is spaced the same distance from all axes capable of expressing power consumption well in consideration that power consumption data is composed of positive numbers using Equation 1 below and may generate a set D={D₁,D₂, . . . ,Dⱼ, . . . ,Dₙ} composed of histogram buffers Dⱼ indicating a frequency distribution using Equation 2 below,

$$\begin{matrix}{C}_{i} = \{ {c}_{k} \vert {c}_{k} = \frac{\vec{1} * {x}_{k}^{p}}{〚 \vec{1} 〛 \cdot ‖ {x}_{k}^{p} ‖} \} & [ Equation 1 ] \\ {D}_{i} = \{ {x}_{i , k}^{p} \vert {c}_{min} + ( j - 1 ) \frac{ϵ}{n} \leq {c}_{k} \leq {c}_{min} + j \frac{ϵ}{n} \} & [ Equation 2 ]\end{matrix}$$

where n is a size of a memory buffer, cₘᵢₙ=min(cᵢ), cₘₐₓ=max(cᵢ), and

$$∈ = \frac{{c}_{max} - {c}_{min}}{n} .$$

In (2) the memory buffer update operation, the hybrid scheduler may generate a set U in which a cosine similarity-based distribution is uniformly distributed using a discrete uniform distribution with a skewness of zero in order to reduce a distribution skewed by the current stream set.

In order to maintain various distributions of data selected to generate the set U in which the cosine similarity-based distribution is uniformly distributed, the hybrid scheduler may be randomly selected in each similarity section using Equation 3 below,

$$U = \{ {x}_{1 , U}^{p} , {x}_{2 , U}^{p} , … , {x}_{j , U}^{p} , … , {x}_{n , U}^{p} \} where P ( x = {x}_{j , U}^{p} ) = \frac{1}{\vert {D}_{j} \vert} \qquad [ Equation 3 ]$$

where a j-th piece of data of the uniform distribution set U selected from data included in a histogram buffer Dⱼ is referred to as x_{j,U}^{p}.

The hybrid scheduler may compare a uniform distribution set, which is the set U in which the cosine similarity-based distribution is uniformly distributed, and a cosine similarity distribution of the previous memory buffer Bᵢ₋₁ in which actual data is stored and may update a data set of the previous memory buffer Bᵢ₋₁ with the uniform distribution set using Equation 4 below when the uniform distribution set has a greater distribution than the previous memory buffer,

Bᵢ=argmaxₓ(cₓ)×∈ {Bᵢ₋₁, U} [Equation 4]

The update of the memory buffer may refer to there being a distribution to be remembered by the hybrid scheduler, and a buffer switching indicator τ indicating the update may be set as expressed in Equation 5 below:

$$τ = \{ \begin{matrix}0 , if {B}_{i} = {B}_{i - 1} \\ 1 , otherwise\end{matrix} \qquad [ Equation 5 ]$$

In (3) the hybrid scheduling operation, considering the distribution of the current data stream, when the distribution increases and a buffer switching indicator τ indicates 1, the cloud server may compute an offline gradient, and the hybrid scheduler may compute a gradient reflecting normalization using the offline gradient and the online gradient computed by the edge server and update model parameters using the computation result, and when the buffer switching indicator τ does not indicate 1, the hybrid scheduler may immediately update the model parameters using the online gradient computed by the edge server.

### BRIEF DESCRIPTION OF THE DRAWINGS

The above and other objects, features, and advantages of the present invention will become more apparent to those of ordinary skill in the art by describing exemplary embodiments thereof in detail with reference to the accompanying drawings, in which:

FIG. 1 is an exemplary diagram illustrating a hybrid deep learning scheduling method for accelerated processing of multi-advanced metering infrastructure (AMI) data stream in edge computing according to an embodiment;

FIG. 2 is an exemplary diagram illustrating a hybrid deep learning scheduling method for accelerated processing of multi-AMI data stream in edge computing according to an embodiment of the present invention; and

FIG. 3 is a flowchart illustrating a hybrid deep learning scheduling method for accelerated processing of multi-AMI data stream in edge computing according to an embodiment of the present invention.

### DETAILED DESCRIPTION OF EXEMPLARY EMBODIMENTS

Hereinafter, a hybrid deep learning scheduling method for accelerated processing of multi-advanced metering infrastructure (AMI) data stream in edge computing according to an embodiment of the present invention will be described with reference to the accompanying drawings.

In the drawings, thicknesses of lines or sizes of elements may be exaggerated for clarity and convenience. Also, the following terms are defined considering functions of the present invention and may be differently defined depending on a user, the intent of an operator, or a custom. Therefore, the terms should be defined based on overall contents of the specification.

As already described above, according to the conventional technique, when the previously learned information is reflected in information to be currently learned for a skewed data distribution that varies greatly, it is possible to greatly improve accuracy through additional computation by using the gradient normalization method. However, the processing speed is decreased, and the system load is increased in a multi-AMI environment.

That is, considering that the additional computation of the conventional technique worsens the system load problem, this embodiment is directed to providing a hybrid scheduling method that reduces the entire system load by performing gradient scheduling in an edge-cloud environment.

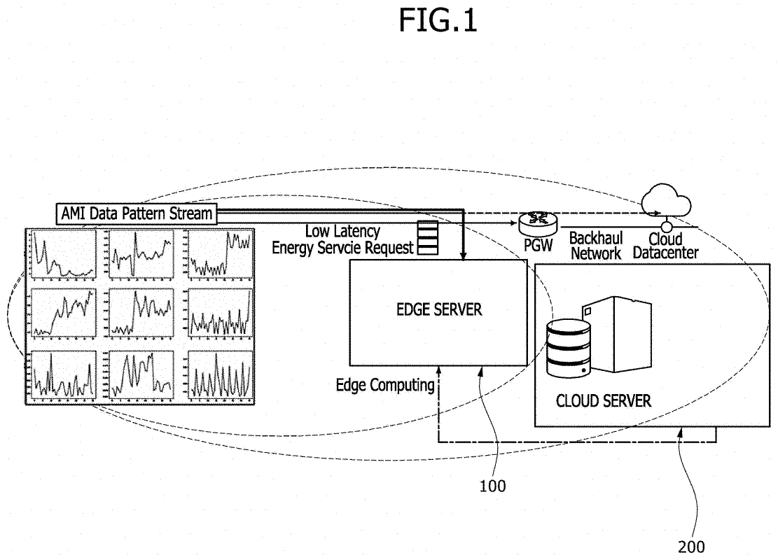

FIG. 1 is an exemplary diagram illustrating a hybrid deep learning scheduling method for accelerated processing of multi-AMI data stream in edge computing according to an embodiment. As shown in FIG. 1, large-scale AMI time-series power data (AMI data pattern stream) is collected and transmitted to an edge server 100 quickly with low latency. The data is reflected in a predictive model inferred by the edge server 100 through an online gradient computed by the edge server 100. In order to reduce the negative impact on a skewed data distribution of AMI data stream, a cloud server 200 recognizes a distribution change and then computes a regularized gradient (or a projection gradient), which requires a complex computation along with historical data, using high computation capability of the cloud server 200. The cloud server 200 sends the regularized gradient to the edge server 100 and updates the model to become a predictive model adaptive to the skewed data distribution.

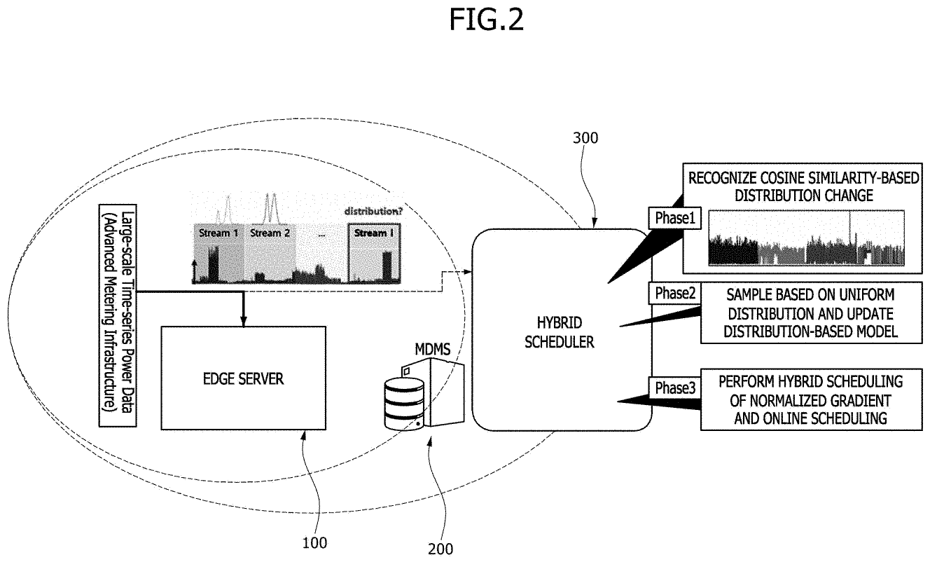

In other words, in the hybrid deep learning scheduling method for accelerated processing of a multi-advanced metering infrastructure (AMI) data stream in edge computing according to this embodiment, a skewed data distribution change, which occurs in AMI data, is detected, the edge server 100 computes an online gradient, which is comparatively quickly computed, on the basis of the detected change, and the cloud server 200 (including a cloud cluster) computes a normalized gradient, which requires a large amount of computation, according to selection by a hybrid scheduler 300 (see FIG. 2).

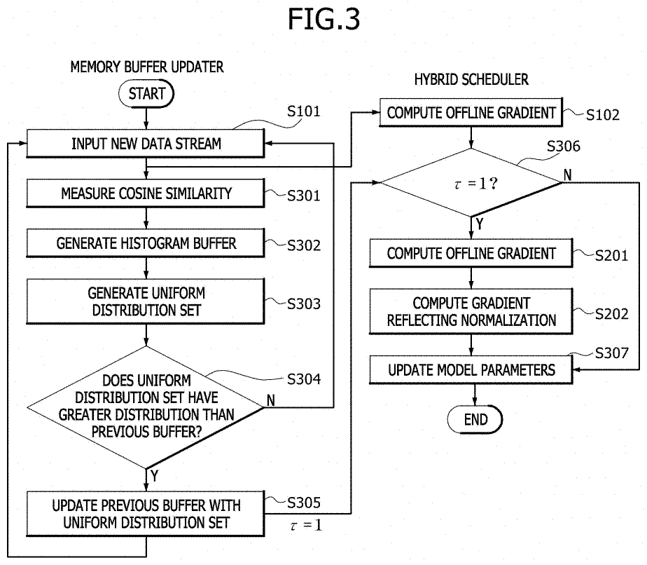

The hybrid scheduler 300 performs a total of three operations: (1) a data stream distribution profiling operation, (2) a memory buffer update operation, and (3) a hybrid scheduling operation, which will be described in detail with reference to FIGS. 2 and 3.

FIG. 2 is an exemplary diagram illustrating a hybrid deep learning scheduling method for accelerated processing of multi-AMI data stream in edge computing according to an embodiment of the present invention, and FIG. 3 is a flowchart illustrating a hybrid deep learning scheduling method for accelerated processing of multi-AMI data stream in edge computing according to an embodiment of the present invention.

The hybrid scheduler 300 recognizes a frequency distribution based on cosine similarity in a stream set Sᵢ={x_{i,1}^{p}, x_{i,2}^{p}, . . . , x_{i,k}^{p}} in which p-dimensional power consumption AMI data xᵢ^{p} is collected for each stream arrangement i, and checks whether a distribution change occurs (i.e., (1) a data stream distribution profiling operation). The hybrid scheduler 300 stores a new data distribution in a memory buffer when it is determined that a distribution change has occurred (i.e., (2) a memory buffer update operation). The hybrid scheduler 300 performs a scheduling technique to solve a problem of a skewed data distribution change according to the new data distribution (i.e., (3) a hybrid scheduling operation).

When a new data stream is input (S101), the hybrid scheduler 300 instructs the edge server 100 to compute an online gradient (S102). In (1) the data stream distribution profiling operation, the hybrid scheduler 300 computes a cosine similarity index (Equation 1) from a data stream with respect to a vector \vec{1} that is spaced the same distance from all axes capable of expressing power consumption well in consideration that power consumption data is composed of positive numbers (S301). The hybrid scheduler 300 generates (or recognizes) a set D={D₁,D₂, . . . ,Dⱼ, . . . ,Dₙ} composed of histogram buffers Dᵢ (Equation 2) indicating the next frequency distribution (S302),

$$\begin{matrix}{C}_{i} = \{ {c}_{k} \vert {c}_{k} = \frac{\vec{1} * {x}_{k}^{p}}{〚 \vec{1} 〛 \cdot ‖ {x}_{k}^{p} ‖} \} & [ Equation 1 ] \\ {D}_{i} = \{ {x}_{i , k}^{p} \vert {c}_{min} + ( j - 1 ) \frac{ϵ}{n} \leq {c}_{k} \leq {c}_{min} + j \frac{ϵ}{n} \} & [ Equation 2 ]\end{matrix}$$

where n is a size of a memory buffer, cₘᵢₙ=min(cᵢ), cₘₐₓ=max(cᵢ), and

$$∈ = \frac{{c}_{max} - {c}_{min}}{n} .$$

Therefore, the frequency distribution is recognized by dividing the distribution by the size of the memory buffer.

Also, in (2) the memory buffer update operation, the hybrid scheduler 300 generates a set U in which a cosine similarity-based distribution is uniformly distributed using a discrete uniform distribution with a skewness of zero in order to reduce a distribution skewed by the current stream set (S303).

A j-th piece of data of the uniform distribution set U selected from the data included in the histogram buffers Dⱼ is referred to as x_{j,U}^{p}.

In this case, pieces of data are randomly selected in each similarity section in order to maintain various distributions.

$$U = \{ {x}_{1 , U}^{p} , {x}_{2 , U}^{p} , … , {x}_{j , U}^{p} , … , {x}_{n , U}^{p} \} where P ( x = {x}_{j , U}^{p} ) = \frac{1}{\vert {D}_{j} \vert} \qquad [ Equation 3 ]$$

Finally, according to a known technique that studied the impact of the bias and variance of ensemble on a learning-based model in order to store various patterns, it can be seen that learning performance increases as the variance of representative data increases. Accordingly, the hybrid scheduler 300 compares a newly constructed uniform distribution set U and a cosine similarity distribution (i.e., the degree of distribution) of the previous memory buffer Bᵢ₋₁ in which data is actually stored (S304). When the uniform distribution set has a larger (higher) distribution than the previous memory buffer, the hybrid scheduler 300 updates the data set of the previous memory buffer Bᵢ₋₁ with the uniform distribution set (Equation 4) (S305).

Bᵢ=argmaxₓ(cₓ)×∈ {Bᵢ₋₁, U} [Equation 4]

In this case, the update of the memory buffer refers to there being a distribution to be remembered by the hybrid scheduler, and thus a buffer switching indicator τ indicating the update is set as expressed in Equation 5 below:

$$τ = \{ \begin{matrix}0 , if {B}_{i} = {B}_{i - 1} \\ 1 , otherwise\end{matrix} \qquad [ Equation 5 ]$$

Also, in (3) the hybrid scheduling operation, a gradient normalization method is used. However, unlike the conventional case, considering the distribution of the current data stream, the gradient normalization method may be used only when the distribution is further increased, that is, only when the model should learn more various patterns. That is, when the buffer switching indicator τ indicates 1 (yes in S306), the hybrid scheduler 300 computes a gradient reflecting normalization (S202).

That is, the cloud server 200 computes an offline gradient (S201), and the hybrid scheduler 300 computes the gradient reflecting normalization using the offline gradient (S201) and the online gradient (S102) computed by the edge server 100 (S202). Also, the hybrid scheduler 300 updates model parameters using this result (S307).

When the buffer switching indicator τ is not 1, the hybrid scheduler 300 immediately updates the model parameters using the online gradient (S102) computed by the edge server 100 (S307).

According to this embodiment, when incrementally training a deep learning model in an edge-cloud environment, it is possible to accelerate the training time and prevent performance degradation for the skewed distribution of the deep learning model.

In order to confirm the effect of the present invention, a comparative experiment with the conventional method with no scheduling was conducted. It can be seen that the hybrid scheduling according to an embodiment of the present invention significantly reduces the total learning because gradients computed for skewed distribution performance degradation are scheduled while effective performance for a skewed distribution is exhibited compared to the conventional technique.

According to an embodiment of the present invention, it can be seen that it is possible to obtain higher accuracy than the incremental learning (see Table 1) and reduce the total learning time by at least 43% compared to the continuous learning technique (see Table 2).

From Table 1 below, it can be seen that when the hybrid scheduling technique according to an embodiment of the present invention is used, effective performance is exhibited similar to that of the conventional technique with no scheduling without a problem caused by the incremental learning. Here, “final ARMSE” indicates an error, and as this value decreases, various data distributions are included until the end and are better used for learning.

TABLE 1

| Learning | Continuous Learning | Incremental Learning | Present |
|---|---|---|---|
| Method | Technique | Technique | Invention |
| final-ARMSE | 0.0918 | 0.246 | 0.0905 |

From Table 2 below, it can be seen that when the hybrid scheduling technique according to an embodiment of the present invention is used, memory processing time is slower than that of a “ring buffer” which stores only recent data and is faster than that of class-wise K-means which stores only representative data using a K-means algorithm for each AMI class compared to the “ring buffer.” According to an embodiment of the present invention, an effect that can be greatly obtained through scheduling is an increase in the total learning time. Although the present invention uses the conventional memory buffer processing technique, it can be seen that when the hybrid scheduling technique according to an embodiment of the present invention is applied, it is possible to reduce the learning time by 43% compared to CosSim with no scheduling.

TABLE 2

| | Continuous Learning Technique with no | | | |
|---|---|---|---|---|
| | Scheduling | | | Present |
| Memory Processing | | Class-Wise | | Invention |
| Method | Ring buffer | Kmeans | CosSim | CosSim |
| Memory Processing | 0.052 | 492.23 | 2.62 | 2.49 |
| Time (ms) | | | | |
| Total Learning Time | 9.58 | 9.99 | 9.09 | 5.22 |
| (s) | | | | |

According to an aspect of the present invention, it is possible to reduce the overall system load by performing gradient scheduling in an edge-cloud environment.

While the present invention has been described with reference to an embodiment shown in the accompanying drawings, it should be understood by those skilled in the art that this embodiment is merely illustrative of the invention and that various modifications and equivalents may be made without departing from the spirit and scope of the invention. Therefore, the technical scope of the present invention should be defined by the following claims. Also, the implementations described herein may be implemented in, for example, a method or a process, an apparatus, a software program, a data stream, or a signal. Even if only discussed in the context of a single form of implementation (e.g., discussed only as a method), the implementation of features discussed may also be implemented in other forms (e.g., as an apparatus or a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, mobile phones, portable/personal digital assistants (PDAs), and other devices that facilitate communication of information between end-users.

What is claimed is:

1. A hybrid deep learning scheduling method for accelerated processing of a multi-advanced metering infrastructure (AMI) data stream in edge computing, wherein
a skewed data distribution change, which occurs in AMI data, is detected,
an edge server computes an online gradient, which is comparatively quickly computed, on the basis of the detected change,
a cloud server computes a normalized gradient, which requires a large amount of computation, according to selection by a hybrid scheduler, and
the hybrid scheduler performs a total of three operations: (1) a data stream distribution profiling operation, (2) a memory buffer update operation, and (3) a hybrid scheduling operation.

2. The hybrid deep learning scheduling method of claim 1, wherein in (1) the data stream distribution profiling operation, the hybrid scheduler determines whether a distribution change occurs by recognizing a frequency distribution on the basis of cosine similarity in a stream set Sᵢ={x_{i,1}^{p}, x_{i,2}^{p}, . . . , x_{i,k}^{p}} in which p-dimensional power consumption AMI data xᵢ^{p} is collected for each stream arrangement i.

3. The hybrid deep learning scheduling method of claim 1, wherein, in (2) the memory buffer update operation, the hybrid scheduler stores a new data distribution in a memory buffer when it is determined that a distribution change has occurred.

4. The hybrid deep learning scheduling method of claim 1, wherein, in (3) the hybrid scheduling operation, the hybrid scheduler performs a scheduling technique to solve a problem related to the skewed data distribution change according to a new data distribution.

5. The hybrid deep learning scheduling method of claim 1, wherein
the hybrid scheduler instructs the edge server to compute an online gradient when a new data stream is input, and in the (1) data stream distribution profiling operation,
the hybrid scheduler computes a cosine similarity index from a data stream with respect to a vector \vec{1} that is spaced the same distance from all axes capable of expressing power consumption well in consideration that power consumption data is composed of positive numbers using Equation 1 below, and
the hybrid scheduler generates a set D={D₁,D₂, . . . ,Dⱼ, . . . ,Dₙ} composed of histogram buffers Dⱼ indicating a frequency distribution using Equation 2 below:
$$\begin{matrix}{C}_{i} = \{ {c}_{k} \vert {c}_{k} = \frac{\vec{1} * {x}_{k}^{p}}{〚 \vec{1} 〛 \cdot ‖ {x}_{k}^{p} ‖} \} & [ Equation 1 ] \\ {D}_{i} = \{ {x}_{i , k}^{p} \vert {c}_{min} + ( j - 1 ) \frac{ϵ}{n} \leq {c}_{k} \leq {c}_{min} + j \frac{ϵ}{n} \} & [ Equation 2 ]\end{matrix}$$
where n is a size of a memory buffer, cₘᵢₙ=min(cᵢ), cₘₐₓ=max(cᵢ), and
$$∈ = \frac{{c}_{max} - {c}_{min}}{n} .$$

6. The hybrid deep learning scheduling method of claim 1, wherein, in (2) the memory buffer update operation, the hybrid scheduler generates a set U in which a cosine similarity-based distribution is uniformly distributed using a discrete uniform distribution with a skewness of zero in order to reduce a distribution skewed by the current stream set.

7. The hybrid deep learning scheduling method of claim 6, wherein in order to maintain various distributions of data selected to generate the set U in which the cosine similarity-based distribution is uniformly distributed, the hybrid scheduler is randomly selected in each similarity section using Equation 3 below:
$$U = \{ {x}_{1 , U}^{p} , {x}_{2 , U}^{p} , … , {x}_{j , U}^{p} , … , {x}_{n , U}^{p} \} where P ( x = {x}_{j , U}^{p} ) = \frac{1}{\vert {D}_{j} \vert} \qquad [ Equation 3 ]$$
where a j-th piece of data of the uniform distribution set U selected from data included in a histogram buffer Dⱼ is referred to as x_{j,U}^{p}.

8. The hybrid deep learning scheduling method of claim 6, wherein the hybrid scheduler compares a uniform distribution set, which is the set U in which the cosine similarity-based distribution is uniformly distributed, and a cosine similarity distribution of the previous memory buffer Bᵢ₋₁ in which actual data is stored and then updates a data set of the previous memory buffer Bᵢ₋₁ with the uniform distribution set using Equation 4 below when the uniform distribution set has a greater distribution than the previous memory buffer:
Bᵢ=argmaxₓ(cₓ)×∈ {Bᵢ₋₁, U} [Equation 4]

9. The hybrid deep learning scheduling method of claim 8, wherein the update of the memory buffer refers to there being a distribution to be remembered by the hybrid scheduler, and a buffer switching indicator τ indicating the update is set as expressed in Equation 5 below:
$$τ = \{ \begin{matrix}0 , if {B}_{i} = {B}_{i - 1} \\ 1 , otherwise\end{matrix} . \qquad [ Equation 5 ]$$

10. The hybrid deep learning scheduling method of claim 1, wherein in (3) the hybrid scheduling operation, considering the distribution of the current data stream,
when the distribution increases and a buffer switching indicator τ indicates 1, the cloud server computes an offline gradient, and the hybrid scheduler computes a gradient reflecting normalization using the offline gradient and the online gradient computed by the edge server and updates model parameters using the computation result, and
when the buffer switching indicator τ does not indicate 1, the hybrid scheduler immediately updates the model parameters using the online gradient computed by the edge server.
